(19) United States
(12) Patent Application Publication
(10) Pub. No.: US 2014/0125997 A1
(43) Pub. Date: May 8, 2014

(54) DEVICE AND METHOD FOR CALIBRATING THE DIRECTION OF A POLAR MEASUREMENT DEVICE

(71) Applicant: Rudolf Staiger, Hattingen (DE)

(72) Inventor: Rudolf Staiger, Hattingen (DE)

(73) Assignee: ZOLLER + FRÖHLICH GMBH, Wangen im Allgaeu (DE)

(21) Appl. No.: 14/128,422

(22) PCT Filed: Jun. 14, 2012
(86) PCT No.: PCT/EP2012/002553

§ 371 Date: Jan. 3, 2014

(30) Foreign Application Priority Data
Jun. 20, 2011 (DE) 10 2011 105 376.3

(51) Int. Cl. G01B 11/00

(52) U.S. Cl. CPC G01B 11/002
USPC 356/614

(57) ABSTRACT

The invention relates to a method and to a device for calibrating the direction of a polar measurement device, in particular of a laser scanner, which includes a reference element which can be or is rotationally fixed to a holding device of a polar measurement device, in particular to a stand, by means of which element a reference direction is defined in a horizontal plane, and which includes a rotating element which is rotationally fixed to the polar measurement device and which can rotate together with the polar measurement device relative to the reference element about a vertical axle, and at least one optical measurement device is provided, by means of which the agreement between an orientation of the rotating element and the reference direction of the reference element can be measured, and in particular signaled.

The invention relates to a device for calibrating the direction of a polar measurement device. By a polar measurement device according to the invention such measurement device is understood which acquires measured values in response to polar coordinates, i.e. preferably in response to an angular orientation in a horizontal plane and an angular orientation in a vertical plane, which is rotated about a vertical axis of rotation during measuring.

One example of such polar measurement device is a laser scanner having a fixed device unit which is immobile during a measured value acquisition and is connected e.g. to a holding device, especially a stand, and having a rotating device unit which during measured value acquisition rotates about a vertical axis relative to the fixed housing part.

By this rotation the measuring direction in a horizontal plane can be predetermined, wherein in the rotating device unit furthermore a transmitting and receiving device is provided by which at a predefined angle in the horizontal direction at plural vertical angular orientations a laser beam is emitted and the reflection signal thereof is detected. At least the running time of the reflection signal is detected, possibly depending on the laser scanner also the intensity of the reflected signal so that it is possible to realize a three-dimensional picture detection of the environment in polar coordinates, i.e. the two angular coordinates in the horizontal and vertical planes.

It is known to operate such polar measurement devices, especially such laser scanners, with a holding device via which the polar measurement device, especially a laser scanner, is held so that the axis of rotation thereof, about which the moved device unit of the laser scanner is rotated vis-à-vis the immobile device unit, is orientated in an exactly vertical direction. For this purpose, for example a stand can be used the stand pillar of which is held to reciprocate so that said pillar is automatically orientated in accordance with gravity perpendicularly and thus vertically, and consequently also the axis of rotation of the rotated laser scanner unit is appropriately vertically orientated.

In particular by way of laser scanners of this type use has become possible in which underground ducts and the course thereof can be detected. For this it is provided, for example, to take three-dimensional environmental pictures by a laser scanner of the afore-described type e.g. upside down, i.e. especially suspended downwards with the rotated device unit of the laser scanner and connected to the holding device by the fixed device unit, wherein such laser scanner can be lowered through vertical duct shafts into the depth, for which purpose a stand column including the suspended laser scanner is lowered through a manhole e.g. at ground level into the duct so as to perform laser scans at one or plural depths and accordingly to take 360° pictures of the duct environment.

Thus it is possible to take pictures of the underground ducting without any site inspection of the ducts by persons.

It has turned out to be difficult that, although pictures of the underground ducting can be taken by such arrangement, it is not evident from such a picture itself, however, at which orientation the ducts are extending relative to a reference on the earth's surface.

Therefore it is the object of the invention to provide a device and a method for calibrating the direction of a polar measurement device such as a scanner which offers the possibility of calibrating a series of measured values acquired by a polar measurement device, especially a pixel cloud taken by a laser scanner and the three-dimensional representation thereof, with a reference, in particular an above-ground reference, so as to put the measured values and the information reproduced by a picture taken at a particular measuring plane of the polar measurement device in relation with comparative data, especially another pixel cloud or a three-dimensional reproduction formed therefrom that originates from a different, especially above-ground measuring plane.

In particular with reference to this duct application which, although representing a preferred application, constitutes no limitation of the invention, the orientation of underground ducts represented in a picture reproduction thus can be put in relation to an above-ground reference picture which shows, for instance, buildings surrounding the duct shaft.

According to the invention, the object is achieved by a device comprising a reference element which can be or, after completed assembly, is rotationally fixed to a holding device of the polar measurement device, for instance to a stand, and by which a reference direction is defined in a horizontal plane, and which further comprises a rotating element that is rotationally fixed to the polar measurement device and can rotate together with the polar measurement device relative to the reference element about a vertical axis, and further comprising at least one optical measuring device, especially an electro-optical measuring device, by means of which the agreement between an orientation of the rotating element and the reference direction of the reference element can be measured, in particular signaled. The rotating element can be rotationally fixed and after assembly is fixed e.g. to the polar measurement device, or can at least be coupled to the polar measurement device in a rotationally fixed manner, unless it is indirectly or directly fixed to the latter.

According to the proceedings, the object is thus achieved by the fact that a reference element is arranged to be rotationally fixed to/in a holding device of the polar measurement device, such as a stand, or is especially fixed, wherein a reference direction is defined in a horizontal plane by the reference element, and that further a rotating element is arranged to be rotationally fixed to/in the polar measurement device which rotating element is rotated together with the polar measurement device relative to the reference element about a vertical axis, wherein by at least one optical measuring device, especially an electro-optical measuring device, the agreement between an orientation of the rotating element and the reference direction of the reference element is measured.

The reference element and the rotating element can be separate components in the design e.g. relative to the holding device and/or to the polar measurement device which components are or can be fixed or are at least coupled to the former in a rotationally fixed manner. These elements can also constitute an integral part of the holding device and/or the polar measurement device, however, e.g. the reference element as an integral part of the holding device and the rotating element as an integral part of the polar measurement device. To all configurations it is merely essential that the electro-optical measuring device includes an optical path and both the rotating element and the reference element are incorporated at least partly in said light path, e.g. by the fact that one or both elements bear or form at least one component of the measuring device so that the light path of the measuring device varies by rotation of at least one of the elements. As a self-supporting element the reference element/rotating element can be in the form of e.g. a rod, a plate or other supporting structure. The physical design of said elements is not limited by the invention.

An optical measuring device, too, can be integrally formed at least partly in the holding device and/or the polar measurement device. However, there will always be a part of the light path of the measuring device that extends between the polar measurement device and the holding device or between the reference element and the rotating element so as to obtain an influence of the light path by a relative rotation.

According to the invention, it is thus possible to carry out a reference measurement, especially a three-dimensional picture recording, which is orientated at the set reference direction predetermined by the reference element by a polar measurement device, for example a laser scanner, in a first horizontal plane.

For this, a reference element can be fixed to a part of the holding device, e.g. a stand, which remains stationary during measurement. It may be provided that the reference direction is defined solely by the fixing or it may also be provided in a configuration that the reference element can be rotatably set in a desired reference direction about a vertical axis of rotation first at the holding device and then is connected to be rotationally fixed to the holding device so as to fix said reference direction.

In accordance with the invention, it is then provided for a first measurement to orientate the polar measurement device, especially a laser scanner, by rotation about the vertical axis such that an agreement between an orientation of the rotating element connected to the polar measurement element and the reference direction of the reference element is given, which can be measured and especially signaled according to the invention by an optical measurement device, in particular an electro-optical measuring device. A measurement, for instance taken in a first plane, especially a three-dimensional picture representation recorded above-ground by a laser scanner, obtains a reference to the fixed reference direction of the reference element and then it is further possible to acquire further measured values by the polar measurement device, especially further picture recordings by a laser scanner, in other horizontal planes, for example after inspecting a duct shaft, for which purpose it is provided to determine an agreement between an orientation of the rotating element and the reference direction of the reference element during each measurement by the optical measuring device and thus to acquire measured values, especially a 3-D picture representation, in a different horizontal plane which is correlated to the previous measurement as regards the orientation.

If, accordingly, in the application during optical duct measurement a three-dimensional picture representation obtained from a duct depth is considered, the course of underground ducts or the orientation of duct openings can be related to an above-ground picture representation showing, for example, the buildings around the duct shaft to which the underground ducts are extending. For instance, with reference to a laser scanner a zero direction, i.e. an angle of rotation about the vertical axis of rotation of the laser scanner can be determined which in all adjustable horizontal planes of the laser scanner can be obtained by displacing a holding element of the holding device, for example a stand column.

In this way it is possible, for instance, to take one single above-ground picture with a reference orientation e.g. as zero degree position and thus as start of vertical rotation and to carry out at least one, possibly more measured values acquisitions in different horizontal planes after inspecting a vertically extending shaft so that each of the three-dimensional 360° views obtained there starts in the same zero degree direction as reference orientation or can be calculated back to the reference orientation, when in each of the set horizontal planes before the start of recording or else during recording the agreement between an orientation of the rotating element and the reference direction of the reference element is determined with the aid of the optical measurement device.

It is a substantial advantage of the invention that the agreement between an orientation of the rotating element and the reference direction of the reference element is brought about purely optically by an optical measuring device and thus any mechanical coupling between said elements can be dispensed with.

Moreover, there is the option to design, by means of an optical measurement device, at least one optical measuring track of the measurement device in the vertical direction between the rotating element and the reference element so that said optical measuring track can be considered to detect the agreement between an orientation of the rotating element and the reference direction irrespective of which height position the polar measurement device adopts relative to the reference element. According to the invention, this independence is resulting from the vertical measuring track which varies only in length but not in direction, if at all, when the horizontal plane of the polar measurement device varies. Thus, according to the invention, the agreement between an orientation of the rotating element and the reference direction of the reference element can be detected for all possible lowering depths of the polar measurement device, in particular of the laser scanner.

In accordance with the invention, it is considered to be especially beneficial when the optical measuring device is formed by at least one light source and at least one light detector, wherein between the reference element and the rotating element at least one measuring track is in the form of a light propagating path in which the at least one light beam generated by the at least one light source vertically propagates within an area between the reference element and the rotating element, and wherein the at least one light detector or an electronic system connected thereto produces an agreement signal in the case of agreement between an orientation of the rotating element and the reference direction of the reference element. Such agreement can be provided in a preferred manner when the at least one vertically propagating light beam impinges on the at least one light detector at least partly, preferably at a predetermined position.

In this case it is insignificant to the measurement and to the device and the method according to the invention whether the at least one generated light beam propagates from the reference element toward the rotating element and thus, due to the stationary arrangement of the reference element, is equally stationary or whether in the opposite direction the at least one light beam propagates from the rotating element toward the reference element and thus the light beam can be moved by the rotating element, in particular about a vertical axis. In each case it is essential that only at a particular angular position of the relative rotating position between the reference element and the rotating element the at least one light beam impinges on the at least one light detector and produces an agreement signal.

Such agreement signal can also be transmitted between the rotating element and the reference element, depending on the element at which an electronic system for producing the signal is provided. The transmission can e.g. be carried out wireless via radio, e.g. by means of a Bluetooth connection or else optically, e.g. via the light beam propagating between the elements.

A possible embodiment may provide, for example, that the at least one light beam propagating in the vertical direction between the reference element and the rotating element is formed by a laser light beam, wherein in this embodiment the agreement between the orientation of the rotating element and the reference direction of the reference element can be detected by means of a light detector.

For example, in this case a light detector or else an electronic system connected thereto can generate an agreement signal resulting from the fact that the light beam propagating in the vertical direction impinges on the light detector after having passed its propagation path between the reference element and the rotating element and thus this event can be detected by measurement.

The agreement between the orientation of the rotating element and the reference direction of the reference element can be brought about, for instance in the most simple configuration, already by one single laser light beam propagating from a laser light source to a light detector in the vertical direction or else by plural light beams each of which strikes a detector, wherein an agreement of the orientation can be achieved from the simultaneous occurrence of an agreement signal of all detectors involved, wherein each of the vertically propagating laser light beams involved may be generated e.g. by its own respective laser light source or else by one single laser light source after appropriate beam splitting.

In an alternative embodiment of an optical measurement device it may be provided, for example, to use a camera as light detector by which within the camera picture, especially within a fixed desired position of the camera picture, the occurrence of a light signal, e.g. a predetermined light pattern, is detected which propagates or is projected in the vertical direction between the rotating element and the reference element and impinges on the camera.

It may be provided in this context, for instance, to fixedly mount a camera at the reference element and to rotate a light source by the rotating element (or vice versa), the light source emitting in the vertical direction a light bundle, e.g. the cross-section of which describes a predetermined pattern normal to the direction of propagation, and to detect by image evaluation when said pattern appears within the camera picture at a predetermined desired position. If this is the case, the agreement between the orientation of the rotating element and the reference direction of the reference element is given.

Irrespective of the concrete design of the light source and the light detector, it is required in each case that at least the optical axis of an emitted light beam and possibly also the optical axis of a light detector detecting said light beam are orientated exactly vertically during the measurements. For this it may be provided, for example, that each light source and/or each light detector is arranged to be self-levelling at the reference element and the rotating element, resp., so as to ensure this required vertical orientation of the respective optical axes in an automated manner. The optical axis of a diverging light bundle can understood to be especially the bisecting line between the marginal beams of the bundle.

In a possible alternative configuration of the device it may be provided that, for example, the rotating element can be or is fixed to a device unit of the polar measurement device which is rotationally fixed, in the measuring operation of the polar measurement device, to the vertical axis of rotation thereof and to the holding device and that before commencement of a measured value acquisition the rotating element is rotatable in the reference direction together with the polar measurement device, for instance manually but also automated by a motor drive, wherein it can then be provided in a preferred configuration that the optical measuring device is arranged for signaling the agreement between an orientation of the rotating element and the reference direction of the reference element. The mounting on the device unit, which is not rotating during measurement, can be performed directly at the latter or else indirectly via an element that is rotationally fixed to the device unit, e.g. to a holding element such as the stand pillar.

In a motor-driven configuration of this variant it may be provided to arrange a motor between the stand pillar and the device unit non-rotating during measuring by which the component non-rotating during operation can be rotated, especially in an automated manner, relative to the stand pillar equally non-rotating during operation prior to measurement so as to reach agreement between an orientation of the rotating element and the reference direction.

In the case of manual or else motor-driven adjustment of the rotating element in agreement with the reference direction of the reference element it may be provided that the optical measuring device provides an acoustic or optical signal or else a trigger signal to inform a user of the device about the agreement of the orientations. Then a user can start measured value acquisition with this found agreement of the orientation of the rotating element and the reference element. The measured value acquisition can also be started automatically by a trigger signal, when the agreement between an orientation of the rotating element and the reference direction was found before in a motor-driven manner.

Also, it can be provided that by means of a motor arrangement the device unit idling about the vertical axis of rotation of the polar measurement device during measuring is motor-driven relative to the reference element and to the holding device, wherein the motor for rotation is controlled until the optical measuring device signals the agreement between an orientation of the rotating element and the reference direction, wherein at this moment the control of the motor is switched off and the rotating element remains at the currently found position, whereupon the measured value acquisition by the polar measurement device can be started either manually or equally automated.

In such configuration it may be provided, for example, that the rotating element can be adjusted together with the polar measurement device for instance by displacing a holding element of the holding device such as an oscillatingly held stand column at different distances from the reference element so that, depending on the distance between the rotating element and the reference element, also the optical light propagating distance between the rotating element and the reference element varies in length. This is no problem, however, as the exactly vertical orientation of the light propagating distance and a preferably oscillating suspension of the polar measurement device ensure that the light propagating distance is located exactly in parallel to the axis of rotation of the polar measurement device.

This exactly is a particular advantage of the device and the method according to the invention, as irrespective of the distance between the rotating element and the reference element and thus irrespective of the height position of the polar measurement device relative to the holding device, the agreement between an orientation of the rotating element and the reference direction can be detected by measurement always by the same optical measuring device, because in this configuration the optical measuring device automatically adapts especially to the length of the propagating path.

A different configuration may also provide that the rotating element and the reference element are stationary relative to each other in the vertical direction, and hence the rotating element does not vary its own height position when the height position of the polar measurement device is varied, e.g. by adjusting or displacing a holding element.

Then it is further provided that the rotating element is rotationally coupled to a holding element movable in the vertical direction of the holding device, i.e. for example to a stand column of a stand, which means that by rotation of the stand column also the rotating element is rotated against the reference element, for instance when the polar measurement device is rotated about the vertical axis, either manually or automated by a motor.

In such configuration it can further be provided that the holding element is movable in the vertical direction through the rotating element. Thus the rotating element and the holding element, especially the stand column, can be displaced relative to each other in this configuration in one dimension, viz. in the height direction, wherein during rotation the rotating element is coupled to the stand column.

This can be achieved, for example, by the fact that a stand column is operatively connected with its shell face to the rotating element, e.g. includes a longitudinal groove in which a projection of the rotating element engages so that in the case of longitudinal displacement of the stand column, i.e. a displacement in the height direction, the stand column can be moved past the rotating element, but during rotation about the vertical axis the rotating element is entrained by the existing engagement.

In such configuration of the device according to the invention, the latter can be mounted for instance completely above-ground to a holding device, especially to a stand, which ensures high measuring accuracy due to the constant especially small distance between the rotating element and the reference element, but requires the coupling operative connection between the rotating element and the stand column upon rotation about the vertical axis.

In a different alternative configuration it may also be provided that the rotating element can be or is fixed to a device unit of the polar measurement device which in the measuring mode of the polar measurement device is rotated about the vertical axis of rotation thereof and relative to the holding device, wherein the rotating element can be rotated during measured value acquisition with the polar measurement device together with the rotating device unit thereof at least once through the reference direction, the optical measuring device being arranged for signaling the agreement between an orientation of the rotating element and the reference direction of the reference element during rotation.

This embodiment does not require previous adjustment of the polar measurement device prior to the commencement of measuring such that the orientation of the rotating element agrees with the reference direction of the reference element. Rather, during a measuring operation in which the rotating element co-rotates with the rotating member of the polar measurement device about the vertical axis, it is automatically detected by the optical measuring device or a connected electronic system when agreement between an orientation of the rotating element and the reference direction of the reference element is provided and this is signaled by a generated signal.

Such signal of agreement between the two orientations can be recorded and stored for example together with the measured values detected by the polar measurement device so that within the measuring values of the polar measurement device a pair of measured values is identified which was acquired at the time of agreement between the orientation of the rotating element and the reference direction of the reference element so that all measured values can be converted to the angle determined in this way in the horizontal plane as starting angle.

For this it may be provided, for example, that the signal provided by the optical measuring device or a connected electronic system is supplied to an interface of the polar measurement device so as to assign the direction reference to at least one pair of measured values from polar coordinates. Since this can be carried out in the duct application described in the beginning both with an above-ground three-dimensional picture by a laser scanner and with at least one underground picture, it is possible to correlate the two pictures as regards their direction in the horizontal plane by way of the pairs of measured values identified in the respective measured values, e.g. by converting the angles in the horizontal plane to a respective starting angle identified by the produced signal.

If it is provided in a laser scanner to sample the angles in the horizontal and vertical directions in time steps, it can equally be provided to detect the agreement signal of the orientations between the rotating element and the reference element as to time and thus to find the horizontal, especially also vertical measuring angles of the polar measurement device which were detected at the instant of agreement of the orientation of the rotating element and the reference element, via the timestamp with the signal of both the measuring instrument of the device according to the invention and of the polar measurement device.

Especially in this embodiment in which the agreement of an orientation between the rotating element and the reference direction of the reference element is detected so to speak “on the fly” during the measured value acquisition, the rotating element will be arranged to be movable together with the polar measurement device in the vertical direction relative to the reference element so that the rotating element varies its distance from the reference element by displacement of the holding element, especially a stand pillar of a stand. Due to the vertical propagation of the at least one light beam within the optical measuring device this is uncritical, however.

In an embodiment of the optical measuring device including at least one laser light source and at least one laser light detector it can be provided that, due to the cross-section of the laser light and the overlapping with a detector surface, the latter provides a spatial resolution so as to be able to detect the position of the projected laser spot of the vertically propagating laser light beam within the total area of the light detector and in this way to evaluate, for instance, when the laser spot adopts a predetermined desired position.

For this, e.g. a light detector can be in the form of a full-surface sensor having a spatial resolution of a plurality of pixels so that, for instance, such laser detector can be realized by a two-dimensional camera chip.

Moreover, there is also the possibility of designing a light detector as quadrant detector so as to detect the relative position between the projected light spot of the laser beam relative to the individual detector quadrants by determining the light intensity sensed in the respective quadrants.

Also any other arrangement can be used as light detector which permits to determine the position of a projected laser spot within the light detector with sufficient accuracy and to generate an agreement signal here from by way of which the agreement between an orientation of the rotating element and the reference direction of the reference element can be signaled.

In a possible configuration it can also be provided to form plural vertical light beams, especially plural vertical laser beams, between the reference element and the rotating element and to assign at least one light detector to each of the laser beams, wherein, as described in the beginning, each of the laser beams can be generated by a separate laser light source or else after beam splitting by one single laser light source.

It is possible in this context, for instance, to arrange all of the light detectors and/or light sources in a line intersecting e.g. the axis of rotation of the polar measurement device. In an alternative configuration, the arrangement can also be chosen such that the line on which the respective light detectors and/or light sources are located is offset with respect to the axis of rotation of the polar measurement device, which allows for an eccentric arrangement of the reference element and/or the rotating element with respect to a holding element of a holding device, especially a stand column.

When plural light beams, especially laser light beams, are employed, it may be provided irrespective of the number of the laser light sources generating the same that also all of the intersections of the laser beams with a horizontal plane are located in a line which intersects, according to the aforementioned first configuration, the axis of rotation of the polar measurement device or, according to the second configuration, is offset with respect to the axis of rotation of the polar measurement device just as the light detectors.

Again in another configuration it may be provided that by the at least one laser light source at least one vertically propagating light beam is generated which is fanned out in a plane parallel to the axis of rotation of the polar measurement device, or in an especially preferred configuration in which the axis of rotation of the polar measurement device is arranged.

For example, such fanning out can be generated by a cylinder lens or a cylindrical concave mirror arranged in the propagation path of a laser light beam. In such case it may be provided to detect the line of the laser beam projected, for example, from the reference element toward the rotating element or vice versa by means of plural light detectors successively arranged in line or by means of a line detector whose detector line is located exactly in the direction of the projected laser light line in the case of agreement between an orientation of the rotating element and the reference element.

When thus all light detectors located in this line or the line detector on the whole with all its light-sensitive elements generate an output signal, the agreement between an orientation of the rotating element and the reference direction of the reference element is detected in this way.

The device according to the invention furthermore also offers the advantage that it can be employed with already existing measuring devices comprising a stand and a laser scanner, because devices according to the invention can be retrofitted to such measuring arrangements according to a special advantage.

For example, merely a reference element has to be fixedly connected to the stand, especially the above-ground part of the stand, whereas the rotating element is fixed directly to the laser scanner, for instance, either to the rotating or the non-rotating device unit thereof.

Appropriate retrofitting can be carried out by fixing these elements to such existing measuring device, thus allowing the transfer of the reference direction of the reference element from the above-ground side of the stand easily into the depth to a laser scanner at the lower end of a stand column due to the optical measuring device.

Hereinafter possible embodiments of the invention shall be described in detail, wherein the figures being discussed merely describe the reference element, the rotating element as well as the optical measuring device comprising at least one light source and at least one light detector, while omitting the representation of the polar measurement device and the holding device, i.e. for example a laser scanner and a stand for holding the latter.

FIG. 1 shows a simple arrangement of a reference element 1 which can be fixed to be stationary e.g. above-ground on a stand supporting a laser scanner at its stand column. By the stationary fixing of the reference element 1, after setting up the stand it is maintained in its once adjusted position which is either immediately defined by setting up the stand or is defined e.g. by a user by rotation of the reference element relative to the stand into a desired position which then is fixed.

In the arrangement shown here a reference direction is defined which is resulting e.g. from the intersection of the axis of rotation 2, which may correspond to the vertical axis of the laser scanner and also to the stand column oscillatingly mounted on the stand, with the reference element 1 as well as the location of the light source, especially the laser light source, 3 fixed to the reference element 1 here. The connecting line between said intersection and the light source 3 therefore constitutes a reference direction in a horizontal plane which is symbolically illustrated by the arrow 4. This reference direction in a horizontal plane, i.e. the one in which the reference element is located, can define in a laser scanner e.g. the zero degree direction on the basis of which a laser scan is started. The exact direction regarding directional parameters such as angular indications in the earth's coordinate system is of no interest in this context.

For starting a scan it is provided in this case to rotate the rotating element 5 fixed on the laser scanner, here especially on the part thereof not rotating during measurement, by rotation of the laser scanner which is not yet measuring about the axis of rotation 2, until the detector 6 thereof having the same radial distance from the axis of rotation 2 as the light source 3 is arranged at the reference element so that the light beam, especially laser light beam 7 projected from the light source 3 in the vertical direction to the rotating element 5 impinges on the light-sensitive surface of the detector 6 and an agreement signal is generated hereby, for example by measuring the light intensity being measured by the detector 6 so that this agreement signal indicates when the rotating element 5 has an orientation according to the arrow 8 which exactly coincides with the reference direction of the arrow 4 of the reference element.

In the arrangement shown here an orientation of the rotating element 5 is defined which is resulting e.g. from the intersection of the axis of rotation 2 that can correspond to the vertical axis of rotation of the laser scanner and also to the stand column, which is fixed to oscillate on the stand, with the rotating element 5 and the location of the detector 6 fixed to the rotating element 5 in this case. The connecting line between said intersection and the detector 6 thus represents the orientation 8 of the rotating element 5.

Upon reaching this agreement which can be reached manually or else by a motor drive for rotating the laser scanner relative to the reference element 1, the laser scan thus can be started which then begins in the zero-degree direction related to the horizontal plane located in the direction of the reference direction 4 or at least adopts a fixed position with respect to the latter.

When in this configuration e.g. an above-ground picture is taken by the laser scanner, any underground picture taken after lowering the laser scanner into a duct can be put in relation to said picture of the above-ground region by the fact that prior to each taking of an underground picture the same orientation 8 of the rotating element 5 toward the reference direction 4 is carried out which can be found for each further measurement in the same way as before by the fact that the light beam 7 propagating in the vertical direction impinges on the detector 6 of the rotating element.

Apart from the orientation of the laser scanner described here before commencement of a measurement, alternatively it can be equally provided to fix the rotating element 5 to the part of the laser scanner rotating about the vertical axis 2 during measuring so that a measurement can be started without previous orientation of the laser scanner at any position and during measured value acquisition of the measured values of the laser scanner at the same time the signal of the optical measuring device, here especially an intensity signal of the light detector 6, is detected which is also recorded in time together with the measured values of the laser scanner so as to determine during measuring when the agreement between the directions 8 and 4 of the rotating element and the reference element is given, i.e. in particular when the maximum intensity of the measured light intensity with respect to a detector 6 has occurred.

Since said agreement signal, in this case especially the maximum intensity, is also recorded for each individual laser scan, it is thus easily possible to standardize the individual three-dimensional picture recordings of the laser scanner to the pair of angular values as to orientation in which the agreement signal of the light detector 6 was simultaneously detected. According to the invention, also in this case each underground duct picture can be correlated as to its direction to an above-ground picture showing, for example, the buildings surrounding the duct shaft into which the laser scanner was lowered at the stand column.

The further figures substantially describe modifications of the optical measuring device with the same possible arrangement of the reference element 1 and the rotating element 5 with respect to the holding device or stand and the polar measurement device or laser scanner, respectively.

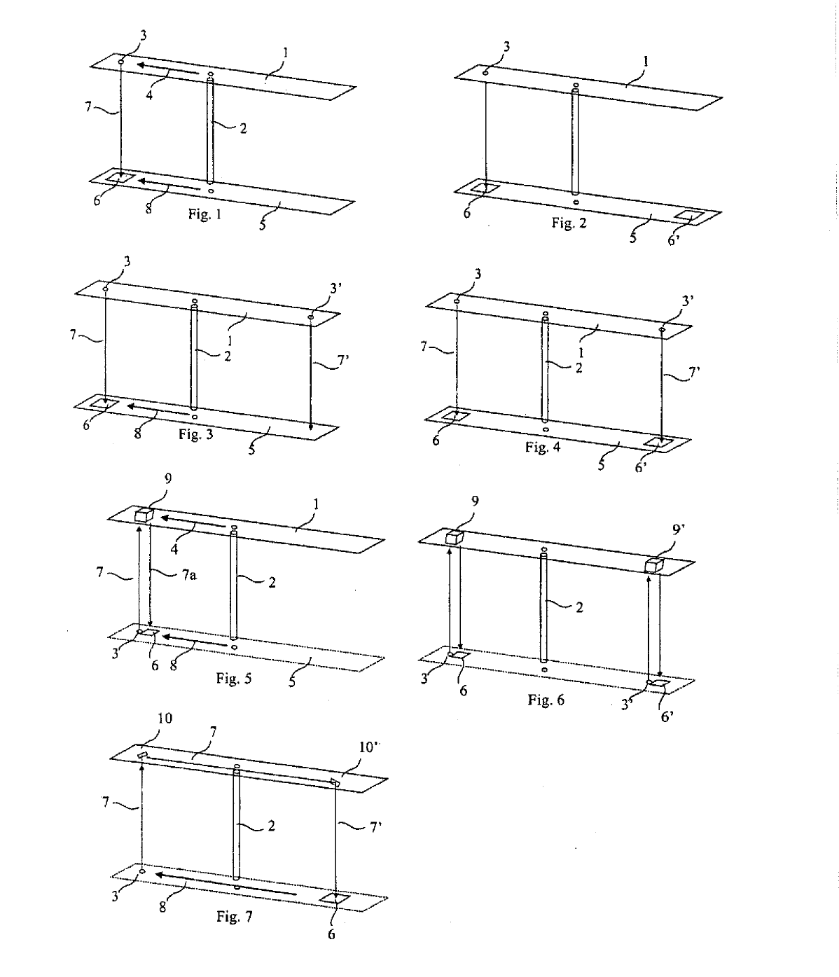

FIG. 2 is modified vis-à-vis FIG. 1 merely in that in the orientation 8 of the rotating element 5 given by the intersection of the axis of rotation 2 with this element and the detector 6 not only a detector 6 but also a further detector 6′ is arranged which is disposed around the axis of rotation 2 offset by 180 degrees with respect to the light detector 6. Consequently, there are resulting two positions at which an overlapping between the light spot generated by the light beam 7 and an illuminated detector 6 or 6′ occurs, thereby two orientations anti-parallel to each other thus being adapted to be detected relative to the reference direction 4 of the reference element 1.

Similarly, FIG. 3 shows the arrangement of two light sources 3 and 3′ being arranged at the reference element 1 at a 180 degree orientation around the axis of rotation 2 and emitting a respective light beam 7 and 7′ downwards to the rotating element 5, wherein in this configuration at the rotating element 5 merely a detector 6 is arranged which defines the orientation 8 of the rotating element in connection with the intersection of the axis of rotation 2 and the rotating element 5.

Hence also in this configuration two orientations anti-parallel to each other are detected which are in parallel or anti-parallel to the reference direction 4 of the reference element and are resulting from the fact that the one detector 6 on the one hand is overlapped by the light beam 7 of the light source 3 and, on the other hand, is overlapped by the light beam 7′ of the light source 3′.

In order to be able to distinguish these two orientations, as only one of them coincides with the desired reference direction, it may be provided, for instance, to design the light beams and the emitting light sources thereof differently and thus the light beams to be distinguishable.

Quite generally and independently of the configurations described here, it may thus be provided for all configurations in which at least two light beams propagate vertically within the at least one optical path of the at least one measuring device that the at least two light beams are designed to be distinguishable from each other. For this, e.g. the light beams can have different intensities or at least one of the light beams can be modulated, for example in terms of time or else in terms of space. The detectors and the connected electronic system thereof thus can be arranged, for example, to check for the presence of such distinguishing feature when a light beam impinges on the detector, in particular wherein an agreement signal is only output when a desired distinguishing feature (modulation in time/space or intensity etc.) has been found in the impinging light beam.

The desired correct orientation of the rotating element relative to the reference direction thus is only given, when among plural distinguishable light beams the respective light beam assigned to a detector impinges on the latter and is detected. Accordingly, it can be provided to perform at least such assignment between at least one of the plural distinguishable light beams and at least one detector. Thus, according to such assignment, there is at least one pair of light beam (or light source generating the same) and detector indicating the correct orientation of the rotating element with respect to the reference direction when the light beam impinges on the detector.

FIG. 4 further illustrates a configuration in which another detector 6′ is arranged, compared to FIG. 3, also to the other side of the axis of rotation 2 and thus orientated by 180 degrees with respect to the detector 6 so that in this case an agreement signal is generated when both detectors 6 and 6′ are overlapped by the light beams 7 and 7′.

The distinction of whether the desired parallel agreement is given (light beam 7 of the light source 3 impinges on detector 6 and light beam 7′ of the light source 3′ impinges on detector 6′) or the anti-parallel position offset by 180 degrees is present (light beam 7 of the light source 3 impinges on detector 6′ and light beam 7′ of the light source 3′ impinges on detector 6) also in this case can be made by the fact that the light beams 7 and 7′ have different intensities or the light source 3′ is temporarily switched off or modulated or any other distinction is provided. Here e.g. the light beam 7 can be assigned to the detector 6 and the light beam 7′ can be assigned to the detector 6′. If the light beam 7 thus impinges on the detector 6′, they form a non-assigned pair of light beam and detector and no agreement signal is generated, as the light beams 7 and 7′ are distinguishable.

In this arrangement the reference direction 4 can be advantageously defined by the connecting line between the light sources 3 and 3′. Correspondingly, the orientation 8 of the rotating element is defined by the connecting line between the two detectors 6 and 6′.

For the definition of a direction (reference direction of the reference element or orientation of the rotating element) it can be provided with general validity preferably for all configurations, also the ones not shown here, that the respective direction is defined between two points of the respective element at least one of which is also part of the optical path of the optical measuring device. Thus a definition of direction can be made e.g. by the point in which the vertical axis of rotation of the polar measurement device and of the stand pillar intersects the respective element and the point in which a detector or a light source or any other optical element of the optical path is arranged at/on said element. Thus the direction can also be defined by two points each of which is part of the optical path, e.g. by the fact that the light source/detector and a mirror or other deflecting element are arranged in these points.

In each of the embodiments of FIGS. 1 and 4 shown here it is provided that the light sources, especially laser light sources, are arranged at the upper reference element 1 and the light beams thereof propagate vertically downwards to the rotating element 5 which then can be rotated for the purpose of reaching an agreement with the reference direction defined by the reference element 1 until the detectors provided at the rotating element indicate an intensity signal. As a matter of course, it is also possible in this case that the light source(s) 3 is/are fixed to the rotating element 5 and the detector(s) 6 is/are fixed to the reference element 1.

Compared to this, e.g. FIG. 5 shows a different configuration in which the light source and the detector are arranged at the same element, viz. at the rotating element 5. The measuring device is configured such that the light source 3 and the detector 6 are disposed directly adjacent each other at a distance from the axis of rotation 2 on the rotating element 5 or are even formed by the same component, the propagating path of the light in this configuration being vertical from the bottom to the top toward the reference element at which a retro-reflector 9 is arranged for reflecting the received light beam 7 as light beam 7a exactly in parallel, possibly laterally offset, in the direction of the rotating element 5 onto the detector 6 arranged adjacent to the light source.

Exactly at the moment when the light detector 6 measures a light signal, the orientation 8 of the rotating element 5 is in agreement with the reference direction 4 of the reference element 1, wherein the reference direction in this case is resulting from the connecting line from the intersection of the axis of rotation 2 with the reference element 1 toward the retro-reflector 9 and the orientation of the rotating element 5 is defined by the connecting line between the intersection of the axis of rotation 2 and the rotating element 5 as well as the light source 3 and the detector 6, respectively.

As a matter of course, in this case it is also possible to fix the light source 3 and the detector 6 on the reference element 1 and to fix the retro-reflector on the rotating element 5.

The configuration of FIG. 6 differs from that of FIG. 5 again by the fact that the optical measuring device is provided twice here, viz. orientated by 180 degrees with respect to each other around the axis of rotation 2. Accordingly, an agreement signal is formed when by both detectors 6 and 6′ the impinging light of the light source 3 and 3′ is detected in the direction of the retro-reflector and back from there after having passed the light propagating path.

FIG. 7 illustrates a repeatedly modified embodiment in which a light source 3 is arranged at the rotating element 5 and at a distance from the axis of rotation so that hereby again the orientation 8 of the rotating element 5 is defined, wherein the entire light propagating path also comprises a horizontal distance portion apart from two vertical distance portions, however. At first the light is guided from the light source 3 vertically upwards to the reference element 1 so as to be deflected from there by means of a mirror, especially a deflecting prism, 10 in the horizontal direction to a point located on the other side of the reference element 1 rotated by 180 degrees about the axis of rotation 2 so that it is reflected then by this mirror, especially the deflecting prism, 10′ again in the vertical direction downwards in the direction of the rotating element 5 at which the detector 6 is arranged equally rotated by 180 degrees about the axis of rotation 2. Thus between the light source 3 and the detector 6 an orientation 8 of the rotating element is defined just as the reference direction of the reference element between the mirrors 10 and 10′. It is obvious that the light beam 7 impinges on the detector 6 after the reflections thereof only when the orientation 8 of the rotating element 5 is in exact agreement with the reference direction, defined by the two mirrors, especially deflecting prisms, 10 and 10′.

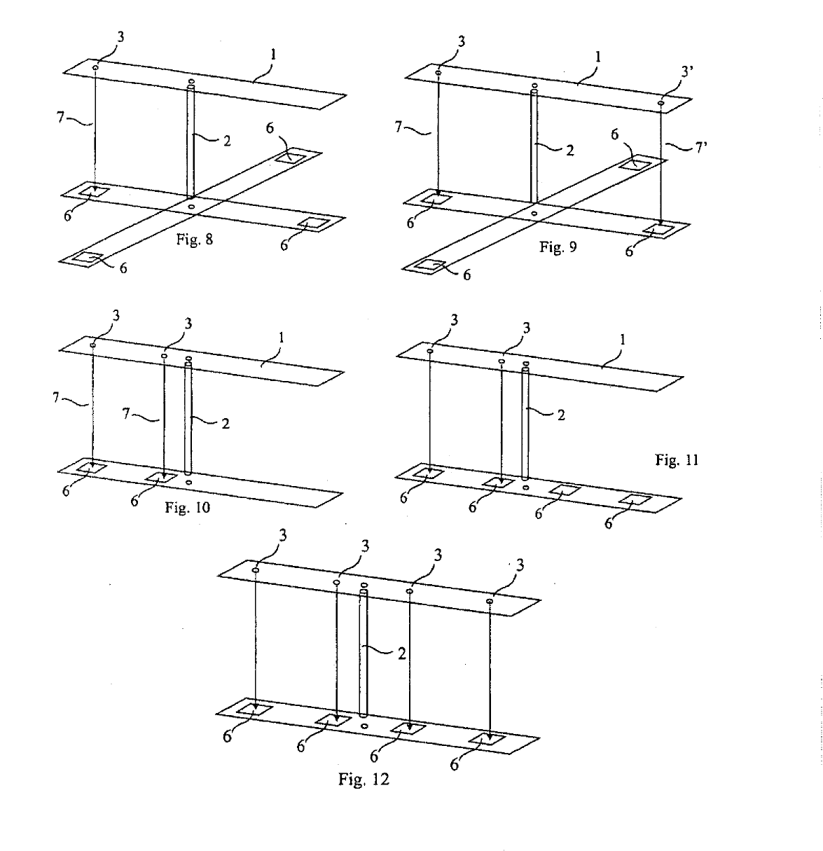

Furthermore the FIGS. 8 and 9 describe an embodiment in which the respective rotating element 5 at an arrangement of 90 degrees relative to each other within the horizontal plane thereof includes respective detectors 6 which thus can be rotated about the axis of rotation 2 together with the rotating element 5. In FIG. 8 the reference element 1 includes one single light source, just as in FIGS. 1 and 2, whereas in FIG. 9 two light sources 3 and 3′ are provided at an arrangement of 180 degrees relative to each other, corresponding to the same arrangement of FIGS. 3 and 4.

Hence also in this case agreement signals are resulting between the orientations of the rotating element 5 and the reference element 1 whenever one light detector in FIG. 8 or two light detectors in FIG. 9 is/are simultaneously overlapped by the light beams 7. In particular with respect to FIG. 8, it can be provided to consider an agreement signal to be detected only when it originates from a particular one of the altogether plural, in this case four detectors 6. When a light signal is detected by one of the detectors 6 other than said predetermined one, an automatic device can calculate from this in which direction e.g. the rotating element has to be rotated automated by a motor so as to rotate the rotating element 5 into the correct orientation defined by the connection between the intersection of the axis of rotation 2 and the rotating element 5 as well as the predetermined detector 6. Thus the target that after a maximum rotation about 180 degrees the laser scanner can be orientated exactly to the correct desired reference direction is reached. As a matter of course, the number of detectors 6 can be further increased.

As further developments the FIGS. 10 and 11 also show the option of providing plural light sources 3 and detectors 6 all of which are arranged on one side related to the axis of rotation 2 in FIG. 10.

Vis-à-vis FIG. 10, FIG. 11 also shows the further development that at least the detectors 6 are arranged on a joint line on both sides of the axis of rotation 2 and thus define the orientation of the rotating element 5.

FIG. 12 illustrates the same arrangement of light sources 3 and detectors 6 each in a line which intersects the axis of rotation 2 so that in this case each light source 3 is assigned to a respective detector 6 vertically located thereunder of the rotating element 5. Thus an agreement of the orientation between the reference element 1 and the rotating element 5 is reached when all detectors 6 receive a corresponding light signal.

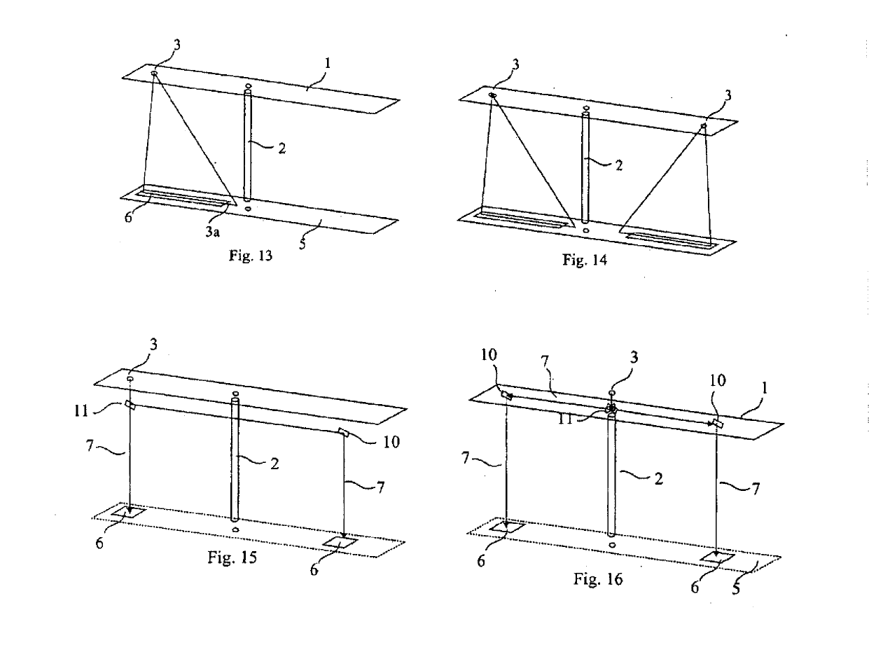

The FIGS. 13 and 14 show two different configurations in which, with respect to FIG. 13 only on one side of the axis of rotation 2 and with respect to FIG. 14 on both sides of the axis of rotation 2 offset by 180 degrees against each other, at the respective reference element 1 at a distance from the axis of rotation 2 a light source 3 is arranged which in the present case, instead of a light beam having a cross-sectional area remaining substantially constant in the propagating direction, now projects a line 3a toward the rotating element 5, wherein it is provided to dispose at the rotating element 5 a longitudinally extending sensor 6 whose geometric longitudinal extension intersects the intersection of the axis of rotation 2 with the rotating element 5.

The FIGS. 15 and 16 describe further embodiments which provide to generate two vertically propagating light beams around the axis of rotation 2 by which a respective assigned detector 6 is illuminated, when the orientation of the rotating element 5 and the direction of the reference element 1 coincide. It is provided according to FIG. 15 in this case to arrange a light source 3 at the reference element 1 by means of which light source 3 a light beam 7 is generated in the vertical direction which is split into two beams at the beam splitter 11, one of said beams being further propagated in the vertical direction and the other being deflected in the horizontal direction toward a mirror, especially a deflecting prism, 10 located on the other side of the axis of rotation 2, by which mirror the light beam is in turn reflected downwards in the vertical direction so that both partial light beams 7 generated only indicate an agreement between the orientation of the rotating element 5 and the reference direction when both of them impinge on the detectors 6.

FIG. 16, on the other hand, shows an embodiment in which an original light beam 7 is supplied to the device collinearly with respect to the axis of rotation 2 and is deflected by a beam splitter 11 in two opposite directions to respective mirrors, especially deflecting prisms, 11 arranged at the reference element 1 orientated by 180 degrees around the axis of rotation 2 so that only when reflected by said mirrors 10 the vertically downwards propagating light beams 7 are generated which in the case of agreement of direction impinge on the respective detectors 6 at the rotating element 5 and thus produce an agreement signal.

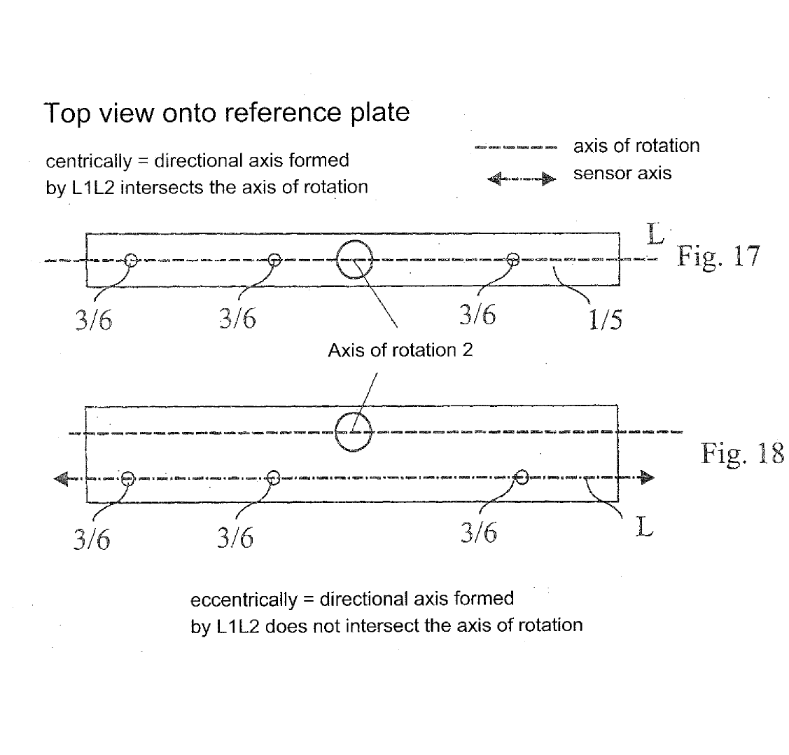

FIG. 17 further shows that in a view in the direction of the axis of rotation 2 the arrangements of light sources 3 and/or detectors 6 can be located either at the reference element 1 or at the rotating element 5 on a line L which accurately intersects the axis of rotation 2. Compared to this, FIG. 18 shows that the connecting line between the light sources 3 and the light beams 7, respectively, is located in a horizontal section in parallel to the reference or rotating element or the detectors 6 are located on a joint line L which is spaced from the axis of rotation 2. In this way it is possible to arrange the reference element and the rotating element and especially the light source(s) and detector(s) eccentrically with respect to the axis of rotation, which can be of advantage in terms of construction.

In all configurations it may be provided that evaluation electronics connected to the one or more light detectors determine when an overlapping between the laser spot and the light detector defining the agreement of the orientations between the reference element and the rotating element is given. For instance, also a control circuit can be realized by which the deviation between a desired position of the laser spot on the detector and the current actual position is minimized, wherein upon reaching this target the agreement of an orientation between the rotating element and the reference direction of the reference element is given. Accordingly, such orientation can also be performed in a fully automated manner by motor control until the agreement signal is generated by the evaluation electronics.

In a different embodiment it may also be provided to determine the agreement of orientation e.g. by polarized light which is projected either from the reference element in the direction of the rotating element or else in the opposite direction and is detected at the respective opposite element by a polarizer connected to the light intensity detector. In this case a maximum or minimum light intensity is detected when the direction of polarization of the polarizer is equal to or perpendicular to the direction of polarization of the vertically propagating light. Hence also this criterion of minimum or maximum intensity can be evaluated at the detector upon rotation about the axis of rotation 2 so as to determine the agreement of direction between the rotating element and the reference element.

1. A device for calibrating the direction of a polar measurement device, wherein it comprises a reference element which can be or is rotationally fixed to a holding device of the polar measurement device, and by which a reference direction is defined in a horizontal plane and which comprises a rotating element that is rotationally fixed to the polar measurement device and can be rotated together with the polar measurement device relative to the reference element about a vertical axis, and at least one optical measuring device is provided by means of which the agreement between an orientation of the rotating element and the reference direction of the reference element can be measured and especially signaled.

2. A device according to claim 1, wherein the rotating element can be or is fixed to a holding element and/or device unit of the polar measurement device which in measuring operation of the polar measurement device is rotationally fixed to the vertical axis of rotation thereof and to the holding device and the rotating element can be rotated before commencement of a measured value acquisition with the polar measurement device in the reference direction.

3. A device according to claim 1, wherein the rotating element and the reference element are stationary relative to each other in the vertical direction, the rotating element being coupled for rotation with a holding element movable in the vertical direction of the holding device, and the holding element being passed through the rotating element movably in the vertical direction.

4. A device according to claim 1, wherein the rotating element can be or is fixed to a device unit of the polar measurement device which in measuring operation of the polar measurement device can be or is rotated about the vertical axis of rotation thereof and relative to the holding device and the rotating element can be rotated during measured value acquisition with the polar measurement device together with the rotating device unit thereof at least once through the reference direction, the agreement between an orientation of the rotating element and the reference direction of the reference element.

5. The device according to claim 1, wherein the rotating element is movable together with the polar measurement device in the vertical direction relative to the reference element.

6. The device according to claim 1, wherein the optical measuring device is formed by at least one light source, and at least one light detector, wherein between the reference element and the rotating element at least one light propagating path being formed in which the at least one light beam vertically propagates in an area between the reference element and the rotating element, wherein the at least one light detector or connected electronics produce an agreement signal in the case of agreement between an orientation of the rotating element and the reference direction.

7. The device according to claim 1, wherein for generating at least one light beam, propagating in the vertical direction between the reference element and the rotating element. the light source and/or the light detector.

8. The device according to claim 1, wherein between the reference element and the rotating element plural vertical light beams, are formed and at least one light detector is assigned to each of the light beams.

9. The device according to claim 1, wherein by the at least one light source at least one vertically propagating light beam is generated that is fanned out in a plane which is located in parallel to the axis of rotation of the polar measurement device or in which the axis of rotation of the polar measurement device is located.

10. A measuring device comprising a holding device of a polar measurement device, wherein it comprises a device according to claim 1.

11. A method for calibrating the direction of a polar measurement device, wherein a reference element is arranged to be rotationally fixed to/in a holding device of the polar measurement device, wherein a reference direction in a horizontal plane is defined by the reference element and a rotating element is arranged to be rotationally fixed to/in the polar measurement device which rotating element is rotated together with the polar measurement device relative to the reference element about a vertical axis, wherein the agreement between an orientation of the rotating element and the reference direction of the reference element is measured by means of at least one optical measuring device.
